(19) United States
(12) Patent Application Publication
(10) Pub. No.: US 2008/0267760 A1
(43) Pub. Date: Oct. 30, 2008

(54) AUTOMATED BAG STACKER

(75) Inventor: Wesley Don Cawley, Port Neches, TX (US)

Correspondence Address: FULBRIGHT & JAWORSKI L.L.P, 2200 ROSS AVENUE, SUITE 2800, DALLAS, TX, 75201-2784, US

(73) Assignee: Sage Automation, Inc., Beaumont, TX (US)

(21) Appl. No.: 11/740,606

(22) Filed: Apr. 26, 2007

(51) Int. Cl. B65G 57/00

(52) U.S. Cl. 414/788.9

(57) ABSTRACT

A method and system for precisely stacking bags by transferring them from a conveyor system onto a bag stacking table that allows the bags to be stacked in a uniform alignment without risking damage to the ends of the bags. As the conveyor feeds bags onto the bag stacking table, the speed of the bag is reduced until it reaches a predetermined stationary position. A friction paddle is used to slow each bag and send a signal to a cylinder to incrementally lower the grid table so that each bag can be stacked with relative accuracy in a way that does not disrupt the normal feed of bags from the conveyor system. Once each set of bags has been stacked, it is removed from the bag stacking table and the process can be repeated.

### TECHNICAL FIELD

The present invention relates generally to a method and system for uniformly stacking bags and more particularly to a method and system for uniformly stacking bags that are transported by a conveyor system so that the bags are not damaged.

### BACKGROUND OF THE INVENTION

A wide variety of bags are used in various industries to encapsulate loose product so that it can be efficiently consolidated, transported, distributed, and marketed to the end consumer of the product. Such bags vary in size, shape, composition, and external marking characteristics, but the general process by which bags of any significant size are manufactured is usually the same or similar. The bags are generally created by a manufacturing system that produces what is essentially a series of concentric flattened tubes of indeterminate length that are eventually cut into pieces that generally correspond with the desired length of the finished bag. The individual tubes are then closed at one end, which becomes the bottom of the bag, and the opposing end of the bag becomes the top of the bag, which is filled with the intended product. Once the bag has been filled with the intended product, the open end is then closed to complete the packaging process.

In the past, the ends of bags have been closed using a type of sewing machine or apparatus to stitch the bottom end of the bag and in some instances the top end of the bag when the bag has been filled with the desired contents. However, this traditional method of closing the ends of bags has been replaced to a large extent by various methods of sealing bags using adhesives to seal either the bottom of the bag, the top of the bag, or both. The trend toward using adhesives in place of traditional sewing or stitching has grown due to the economics of adhesive systems when compared to conventional sewing systems as well as the improved adhesives and techniques for sealing the ends of bags when compared to the conventional sewing process that uses various stitch materials, stitch widths, and stitch lengths, depending on the nature of the contents to be enclosed in the bag. Other problems related to the efficiency and cost of the sewing process as well the possibility of inconsistent seams has contributed to the increased use of adhesives for sealing bags.

The use of adhesives to seal bags has brought with it other challenges due to the nature of the adhesive application and curing requirements. The automation of processes designed to apply adhesives in this manner generally requires a degree of precision with regard to the stacking of these concentric flattened tubes that had not been a concern when a seam was created by mechanically connecting the opposing sides of each individual tube using sewing techniques. Also, the increasing use of such bags to package products such as pet food, concrete, and countless agricultural products, has led to the development of a wide variety of individual concentric tubes, frequently made of dissimilar materials.

Considerations that have led to the development of differing compositions for individual concentric tubes include protection of the product, insulation of the product, as well as marketing of the product, each of which may not be effectively achieved using a single ply material. For example, an inner layer may be chosen for its propensity not to affect the taste or composition of a product, such as pet food, even when stored for a long period of time inside the bag. An intermediate layer may be chosen merely to insulate or separate the inner and outer layers to prevent undesirable chemical interactions between the materials used for the inner layer and the outer layer. An outer layer may be comprised of a shiny material that is designed to retain ink in such a way that the marketing properties of the product are maximized. As the effective marketing of products considered to be commodities has grown in importance, the overall appearance of the marketed product has become an important factor in the packaging decision making process.

Although the use of adhesives to seal bags has distinct advantages over sewing methods with respect to overall cost, speed, and seal quality, the nature of the sealing process requires a degree of precision with respect to placement, alignment, and layer consistency that was not required using conventional sewing methods. For instance, it is generally not necessary that the ends of the bag be in pristine condition when using sewing methods to seal the bags since the nature of the sewing process does not particularly depend on the condition of the bag end. Similarly, precise alignment of the bag when using a sewing method will not necessarily impact the quality of the seal, which is largely the same as long as the sewing material pierces each bag layer and the thread interlocks as intended. However, the nature of adhesive application and the related sealing process, especially with respect to bags with multiple layers, usually requires that the bags enter the sealing process in the proper configuration and alignment. Further, the edges of the layers that comprise the wall of the bag need to be fairly straight (i.e., not bent) in order for an automated adhesive application process to perform the necessary functions in an efficient manner.

Generally, between the cutting of the continuous concentric tubes into individual concentric tubes and the sealing process, the bags are layered, or shingled, so that each bag overlaps another bag as the bags travel along a conveyor system after the individual concentric tubes have been created. The bags may then be stacked so that each stack includes a predetermined number of bags or stack height. Once the appropriate stack has been compiled, the stack can then be removed from the conveyor system so that it can be transported to a system that performs the sealing application process, which may be at the same facility or at another facility. In the latter case, the stack is simply staged for eventual shipment to the facility that will perform the sealing process.

Because alignment of the bags is not especially critical when the ends of the bags are sewn, the usual process is to simply feed the bags from the conveyor system at a relatively high rate of speed (e.g., 100-200 ft per minute) into a collection area where the forward progress of each bag is halted when the end of the bag hits a vertical surface located at the collection area, which causes the bag to essentially fall on top of the previous bag. While this method is not necessarily a problem when the bag sealing is accomplished using sewing methods, it causes a variety of problems when adhesive sealing techniques are used. For example, when the bags hit the vertical surface at a high rate of speed, the ends of the bags can bend, which can compromise an adhesive process that requires all appropriate surfaces be exposed to the adhesive used to seal the bag. This may be further complicated in bag designs in which the ends of the bag are cut in such a way that individual layers are staggered and bending of the outermost layer can prevent the necessary surfaces from being adequately exposed to the adhesive.

Another problem with present systems deals with the precision with which bags are stacked into uniform piles. Because of the precise nature of certain adhesive application procedures as well as the requirements of related equipment used to accomplish the adhesive application, it is desirable for the stacks of bags to be as uniform as possible and the for the bags to be properly aligned (i.e., all four edges of the bag lined up with the other bags in the stack). Although such precision was not necessary when using sewing sealing techniques, misalignment of bags has the potential for disrupting the adhesive application process and/or requiring manual intervention in what might ideally be a completely automated system.

### BRIEF SUMMARY OF THE INVENTION

The present invention claims a system for stacking bags that are moved from a conveyor system onto a bag stacking table where the bags are uniformly stacked. The system is comprised of an adjustable table that can be raised and lowered, a friction paddle assembly, and means by which the adjustable table can be raised and lowered. The friction paddle assembly monitors the stacking of the bags and signals when the table is to be incrementally lowered as each individual bag is stacked.

The present invention also claims a method for stacking bags that are moved from a conveyor system onto a bag stacking table where the bags are uniformly stacked. Each incoming bag is transferred onto the bag stacking table and friction is applied to each of the bags to slow and stop its forward progress using a friction paddle assembly. Once a sensor detects that a bag has been stacked, a signal is sent to incrementally lower the bag stacking table. When the signal is received, the adjustable table is incrementally lowered.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1A is front view of the end of an exemplary concentric tube;

FIG. 1B is a perspective view of an exemplary concentric tube;

FIG. 2 is a side view of an embodiment of the present invention that is used to stack bags;

FIG. 3 is a side view of an embodiment of the friction paddle apparatus;

FIG. 4 is a side view of the present invention showing layered bags being processed and stacked;

FIGS. 5A-5E are side views of an embodiment of present invention showing bags and they exit the conveyor system, are stacked, and are removed from the stacking table;

FIG. 6 is a side view of an embodiment of the present invention in which two stacking tables are fed by a conveyor system; and

FIG. 7 is a side view of an embodiment of a conveyor system designed to feed a stacking table.

### DETAILED DESCRIPTION OF THE INVENTION

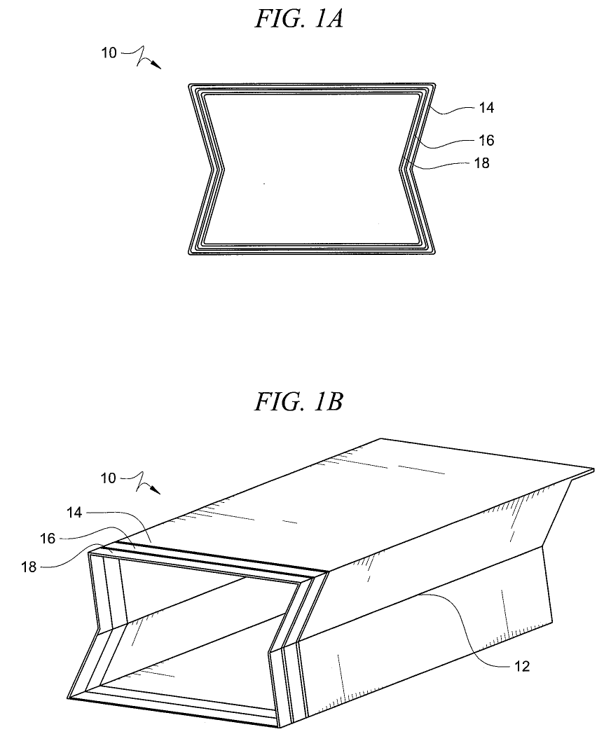

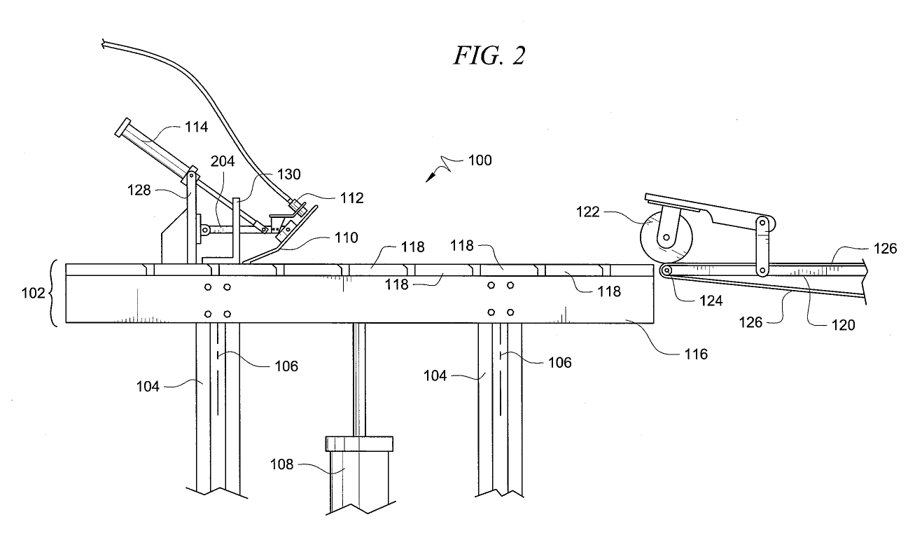

FIG. 1A shows the end of an exemplary concentric tube 10 that illustrates the multiple layers that may make up a single tube. For illustrative purposes, tube 10 is shown somewhat expanded and the thickness of each individual layer is exaggerated though individual layers are not likely to be much thicker than a few pieces of paper. FIG. 1B is a perspective view of exemplary concentric tube 10 that again shows the bag somewhat expanded to better illustrate the individual layers that make up the bag. However, once the bags are moving toward the stacking system, the bags have been collapsed along side creases 12 and lie generally flat. Although FIG. 1B shows exemplary tube 10 with each layer having straight ends, many tube configurations have layers in which the ends are made up of individual fingers or ridges that may extend out a fraction of an inch and that are generally aligned so as to form the end of the tube. For example, a tube spanning 18 inches along its ends may have an end formed of 50 individual fingers or ridges. Such configurations further decrease the stability of the ends and increase the susceptibility of the ends to unwanted bending. Outer layer 14 may be made of a shiny material that is conducive to retaining ink and/or providing maximum protection to the inner layers of the bag and its contents. Intermediate layer 16 may be used for insulation or to otherwise separate outer layer 14 from inner layer 18. Inner layer 18 may be made of a material that preserves the quality of the eventual contents of the bag.

These layers may eventually be bonded together by applying adhesives to the individual layers and implementing whatever curing process is appropriate under the circumstances. Because the separation between the layers is necessarily slight, the adhesive application process is usually precise and requires that the bags be properly aligned and undamaged by the stacking process that precedes the adhesive application procedure. If a bag were stacked in such a way that the edge of one of the layers was bent, the integrity of the seal may be jeopardized if the adhesive is not allowed to reach its intended surfaces. Likewise, due to the precise nature of some automated adhesive application systems, bags that are not properly aligned during the stacking process may not be properly positioned when the adhesives are applied, resulting in a seal that is less than ideal. These situations should be avoided, especially when an unsatisfactory seal can destroy the value of the contents within.

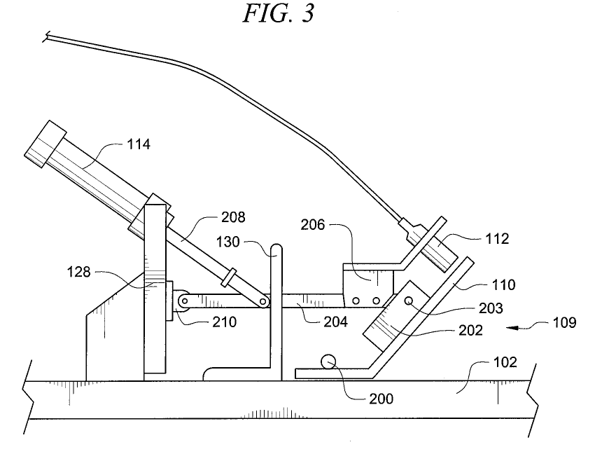

FIG. 2 shows an embodiment of the present invention in which bags are stacked until a bag stack of a predetermined height or quantity has been reached, at which point the stack of bags can be removed from bag stacking table 100. In this embodiment, table base 116 of pick grid 102 is connected to linear rails 106 that are mounted onto table legs 104. Connected to the bottom of table base 116 is pneumatic cylinder 108. Friction paddle 110, proximity sensor 112, and actuating cylinder 114 are mounted independently from pick grid 102 and do not necessarily move in concert with the raising or lowering of pick grid 102, which may be constructed from a variety of materials (e.g., metal, wood, plastic). Staggered planks 118 of pick grid 102 are appropriately sized and spaced to facilitate the removal of each stack of bags from pick grid 102 once the stacking process has been completed.

Referring still to FIG. 2, table legs 104, linear rails 106, and pneumatic cylinder 108 provide for the structure by which pick grid 102 is able to be lowered as the bags are stacked onto pick grid 102 and raised once the stacking process has been completed. Linear rails 106 are essentially one or more vertical tracks mounted onto table legs 104 on one or more sides of stacking table 100 that allow for relatively precise vertical movement of stacking table 100. The actuation of pneumatic cylinder 108, which is mechanically attached to the bottom of pick grid 102, powers this vertical movement by retracting to incrementally lower pick grid 102 as bags are being stacked and extending to raise pick grid 102 after a set of bags has been stacked and is ready for removal from pick grid 102. Although this embodiment shows a single pneumatic cylinder that is used to raise and lower pick grid 102, it is to be expressly understood that any means to raise or lower pick grid 102 may be used, including multiple cylinders or other means to raise or lower the table. Such cylinders or other lifting means may be fluid powered, electrically powered, or otherwise use a prime mover capable of raising and lowering pick grid 102, such as a gear and teeth assembly.

Bags enter onto pick grid 102 from conveyor system 120 by passing in between two rollers 122/124 at the end of a conveyor belt. Pinch roller 122 is mounted to the conveyor system so that it hangs over and presses down onto the exiting bags as they leave conveyor system 120. On the conveyor side, nose roller 124 has a comparatively smaller radius in order to improve the accuracy of the bag placement system. As the radius of nose roller 124 decreases, the bags will be driven onto the stacking table with maximum control as the force from the conveyor will act upon the bags almost up to the exact point where the bag exits conveyor system 120 onto pick grid 102. Conversely a nose roller with a larger radius would effectively create, or significantly increase, the gap between conveyor system 120 and pick grid 102 by approximately the length of the radius of the nose roller as measured from the crest of the nose roller to the leading edge of pick grid 102. For this reason, a smaller nose roller is preferred in this embodiment of the invention.

As bags move from conveyor system 120 onto pick grid 102, the bags are slowed or stopped by the friction paddle assembly. Friction paddle 110 and proximity sensor 112 are connected to actuating cylinder 114 and mounting assembly 128 through mounting bar 204. Also shown in FIG. 2 is adjustable endstop 130, which can be used to demarcate the final stopping point of the bags once they are stacked. Adjustable endstop 130 also acts to prevent bending at the bag ends because it provides a structure where the combination of adjustable endstop 130 and the vertical forces from bags being stacked on top of each other acts to prevent bending of the ends of the bags as they reach or make contact with adjustable endstop 130. Adjustable endstop 130 can be moved laterally along the length of the table so that the absolute stopping point for the bags can be modified based on the length of the bags being stacked.

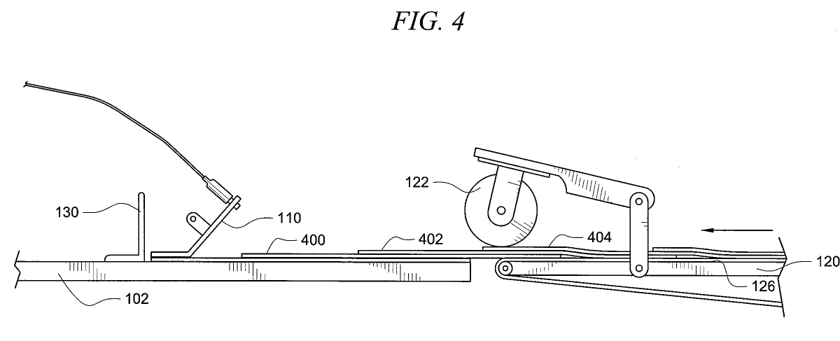

FIG. 3 provides an expanded view of an embodiment of friction paddle assembly 109. Friction paddle 110, here shown with bar 200, is connected to friction paddle assembly 109 by paddle mounting bracket 202. Bar 200 adds weight to the lower portion of friction paddle 110, thereby encouraging proper rotation of friction paddle 110 about pivot point 203 and improving friction between friction paddle 110 and incoming bags to be stacked. Paddle mounting bracket 202 is pivotally connected to mounting bar 204 with a hinged connector allowing friction paddle 110 to pivot at point 203. Also connected to mounting bar 204 is sensor mounting bracket 206, which secures proximity sensor 112 in a stationary position in relation to pivoting friction paddle 110. Actuating cylinder 114 is mounted on the top of mounting assembly 128 and piston 208 is attached to mounting bar 204 in between friction paddle and hinge bracket 210. Hinge bracket 210 allows actuating cylinder 114 to retract friction paddle 110 away from pick grid 102 when a complete stack of bags is ready to be removed from pick grid 102.

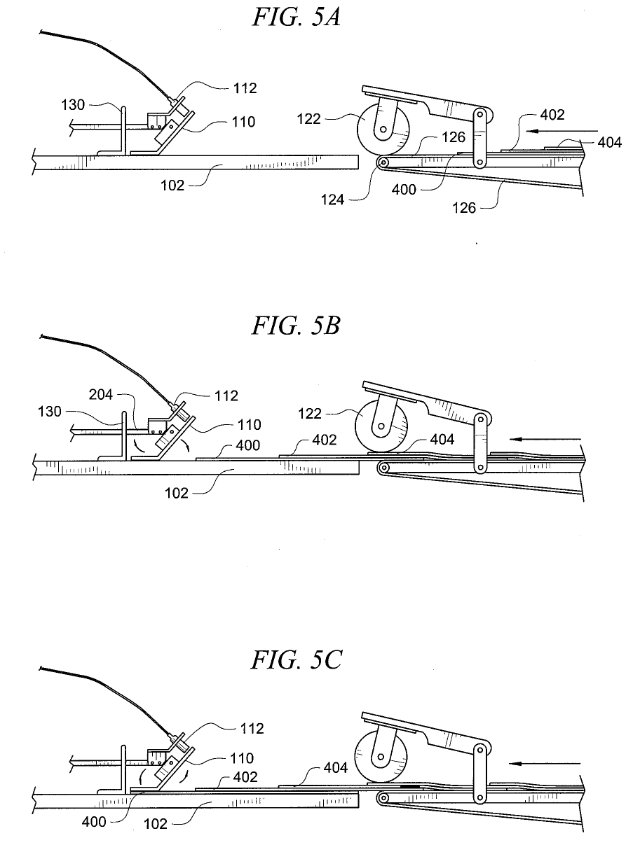

FIG. 4 is a side view of an embodiment of the bag stacking table that illustrates the applicable forces acting on the bags throughout the process. The incoming bags 400/402/404, which are conveyed in a layered, shingled configuration, are generally flat since they are supported by conveyor system 120, which allows the bags to be pushed by conveyor belt 126. Pick grid 102 acts as the surface on which the bags are stacked and also provides friction to slow the progress of first incoming bag 400 as it leaves conveyor system 120. As shown in this embodiment, first incoming bag 400 has been stopped by the friction from pick grid 102 and the friction from friction paddle 110 and both of these forces contribute to the slowing and stopping of first incoming bag 400. Second incoming bag 402 is pushed forward by the friction and forward force provided by conveyor belt 126 as well as the friction provided by third incoming bag 404 that is layered on top of second incoming bag 402 and is also moving forward. Although the bag surface area of second incoming bag 402 that is in contact with first incoming bag 400 (bottom of bag) and the bag surface area that is not in direct contact with third incoming bag 404 (exposed surface area on top of bag) are resisting forward motion, these combined forces are lower than the friction and forces exerted on second incoming bag 402 by the forward momentum provided by conveyor belt 126 and third incoming bag 404. This is due, in part, because pick grid 102 has been lowered to the point where second incoming bag 402 is moved forward while traveling flat and in a straight line.

When second incoming bag 402 reaches the end of conveyor system 120, the inertia and friction provided by third incoming bag 404 forces second incoming bag 402 to move forward until the friction provided by friction paddle 110 (acting on the top of second incoming bag 402) and the friction provided by first incoming bag 400 (acting on the bottom of second incoming bag 402) brings second incoming bag to a controlled stop before hitting adjustable endstop 130. In the illustrated embodiment, there are both forces acting to move each bag and forces acting to stop each bag. These forces operate at different magnitudes during the various stages of the bag stacking process. When a bag is in contact with conveyor belt 126 it is subject to that positive force acting to move the bag forward onto pick grid 102 as well as the forward force exerted upon it by the bag in front of it and the bag following it, assuming it is not the last bag in the set. At the same time, friction forces acting to stop the bag include friction acting on the bottom of the bag (from pick grid 102 or the bag immediately preceding it) and eventually the friction from friction paddle 110, and perhaps even adjustable endstop 130 to a minor extent. As the bags are moved onto pick grid 102, the forces pushing the bag onto the table are strong enough to keep the bag moving forward. However, once the bag leaves conveyor system 120, the forces pushing the bag forward are eventually overcome by the friction exerted on the bottom of the bag and the friction exerted on the top of the bag by friction paddle 110. After leaving conveyor system 120, the forces still pushing the bag forward can be largely attributed to momentum in the system that is eventually eliminated by the stopping forces exerted onto the bag, at which point the bag comes to a controlled stop at the point where it may come into contact with adjustable endstop 130.

It is important to note that the shape and placement of friction paddle 110 has a great impact on the ability to stop the bags and stack them in the desired manner. In a preferred embodiment, the shape of the lower portion of friction paddle 110 is flat with respect to pick grid 102. The close proximity of friction paddle 110 to adjustable endstop 130 keeps bags from escaping from the bag stacking table in situations where a bag may exceed its desired forward movement along pick grid 102. Because the final bag in the process will not have the additional friction of a bag laying on top of it, in order to obtain the accurate positioning as the rest of the bags in the set, pinch roller 122 may shift forward (approximately ¼ inch in this embodiment) to provide the additional force to move the final bag forward.

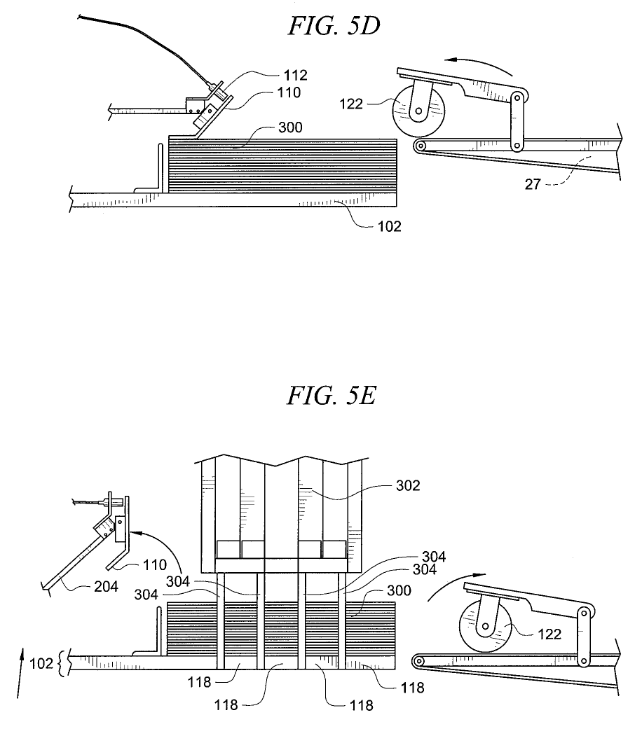

FIGS. 5A-5E are side views of an embodiment of present invention showing the operation of the system as bags exit from the conveyor system, are stacked, and are removed from the automated bag stacking table. FIG. 5A shows the initial state of the invention in which pick grid 102 is positioned with the surface of the table substantially level with the surface of conveyor system 120. In the initial state, adjustable endstop 130 may be adjusted forward (toward the incoming bags) or backward (away from the incoming bags) depending on the dimensions of the bags to be stacked. As shown in FIG. 5A, bags are transported from conveyor system 120 in a shingled configuration where the bags are laid on top of each other but staggered so that each bag extends some distance ahead of the bag immediately following it. A set of bags is a predetermined number of bags that make up a stack. Each set of bags is initially a continuous line of bags that are layered in the shingled arrangement on a conveyor system that feeds the stacking table.

Conveyor belt 126 moves the first bag 400 onto pick grid 102 in between pinch roller 122 and nose roller 124. Although pinch roller 122 may not have an independent source of rotation on its axis, it nonetheless is driven by forces from conveyor system 102 and adds friction and downward force onto the bag to facilitate each bag's forward motion as it leaves conveyor system 120. In one embodiment of the invention, once the last bag of the set reaches pick grid 102, pinch roller 122 will move toward pick grid 102 a predetermined distance in order to provide additional forward motion that may be necessary to accurately position the last bag of the set onto the top of the stack. Nose roller 124, which drives conveyor belt 126 as it rotates, may be significantly smaller in diameter when compared to pinch roller 122. A relatively small nose roller can allow for more accurate bag transfer from conveyor belt 126 onto pick grid 102 and reduce inconsistencies in the stacking process because the relatively small radius of nose roller 124 minimizes the gap between the crest of nose roller 124, which is effectively the last point of contact between conveyor belt 126 and the exiting bags, and the leading edge of pick grid 102. A significant gap could adversely affect the precise placement of the bags onto pick grid 102 and could have an especially detrimental impact as the trailing end of the last bag in a set leaves conveyor belt 126 at the crest of nose roller 124. Therefore, a preferred embodiment of this invention uses a nose roller with a relatively small diameter (e.g., 0.5 inches).

Also shown in its initial state in FIG. 5A is friction paddle 110, which is shown with its bottom end making contact with pick grid 102. A preferred embodiment of the invention is designed so that the lower portion of friction paddle 110 lies almost perfectly flat with respect to pick grid 102, which increases the available surface area with which friction paddle 110 can act on the incoming bags. In this way, friction paddle 102 can be designed to maximize its functionality as a friction brake and reduce the chances of a collision between incoming bags and adjustable endstop 130. When friction paddle 110 is in this initial state, proximity sensor 112 senses the upper end of friction paddle 110, which is considered the normal state of proximity sensor 112. Depending on the embodiment of the invention, the sensor output may be normally open, normally closed, PNP, NPN, or a combination of outputs may be used depending on the preferred wiring scheme or input signal needed for the pick grid lowering process. Regardless of the output type, there is effectively no signal sent to the pick grid lowering means while proximity sensor 112 senses the upper end of friction paddle 110.

FIG. 5B shows a set of bags being conveyed through pinch roller 122 and entering onto pick grid 102. As the momentum of first incoming bag 400 propels it toward adjustable endstop 130, first incoming bag 400 is slowed by friction paddle 110. As a result, each bag will usually stop before it reaches adjustable endstop 130 so that bags with fragile ends will not be damaged by colliding with adjustable endstop 130. The contact between friction paddle 110 and the incoming bag also causes the lower portion of friction paddle 110 to pivot upward from its connection point with mounting bar 204 and causes the upper portion of friction paddle 110 to pivot downward from the same connection point. Before the bag makes contact with friction paddle 110, proximity sensor 112 is in its normal state. Once the upper portion of friction paddle 110 pivots downward, proximity sensor 112 stops sensing the presence of friction paddle 110 and this change in the state of proximity sensor 112 signals the pneumatic valve to lower pick grid 102 to facilitate the proper positioning of the next bag. Pick grid 102 is incrementally lowered to account for the thickness of each bag being stacked so that the each bag will enter onto pick grid 102 under similar conditions as the bag immediately preceding it. Incrementally lowering pick grid 102 as bags are stacked to create substantially uniform stacking conditions for all of the bags contributes to the accuracy and consistency of the stacking process.

As shown most clearly by reference to the embodiment shown in FIG. 2, the lowering of pick grid 102 may be accomplished by using pneumatic cylinder 108 to incrementally lower pick grid 102 once it receives the signal to do so. Pick grid 102 is supported by table legs 104, upon which are mounted linear rails 106. As shown in the embodiment in FIG. 2, table legs 104 are located along the far side of pick grid 102, which is raised and lowered by pneumatic cylinder 108. Pick grid 102 rides along linear rails and is incrementally lowered when pneumatic cylinder 108 receives the appropriate signal from proximity sensor 112. In one embodiment of the invention, proximity sensor 112 is hardwired to the input contacts of pneumatic cylinder 108 to signal the cylinder to retract. In other embodiments, proximity sensor 112 may be connected to an intermediate device, such as an electromechanical relay, a solid state relay, or a programmable logic controller, which may accept input signals from proximity sensor 112 and send the appropriate output signals to pneumatic cylinder 108. Such intermediate devices may be used to fine tune the system or coordinate other automated or manual processes with the bag stacking application.

FIG. 5C shows the state of this embodiment of the invention immediately after pick grid 102 has been incrementally lowered and the next bag 402 is moving toward adjustable endstop 130. Once pick grid 102 has been incrementally lowered, friction paddle 110 returns to its initial state except that the bottom end of friction paddle 110 is now making contact with the most recent bag to be stacked as opposed to pick grid 102. When friction paddle 110 returns to its initial state, proximity sensor 112 re-detects the presence of friction paddle 110 and returns to its normal state. The process shown in FIGS. 5B and 5C is repeated until all of bags to be stacked have been processed.

FIG. 5D shows an embodiment of the invention in which pinch roller 122 is shifted forward toward pick grid 102 when the final bag is being stacked. This will ensure that the forces acting on the last bag will be similar to those acting on the preceding bags even though the last bag will not have any bag layered on top of it. Once the final bag of the set of bags to be stacked has stopped, the resulting stack 300 should be at rest on pick grid 102, ready for unloading. At this point friction paddle 110 is again in its initial state and proximity sensor 112 is in its normal state.

FIG. 5E shows an embodiment of a stack unloading process that may be initiated once the complete set of bags has been stacked. Once the final bag of the set has been stacked, a signal to prepare the table and stack for unloading may be initiated. Such a signal may be sent manually using a pushbutton, toggle switch, or other actuator, or may be sent automatically, for example, by using a sensor, such as a photoelectric or proximity sensor. Such a sensor might detect when the last of the bags has been moved from conveyor system 120 onto pick grid 102 or when pick grid 102 has reached its lower limit. The unload signal acts to actuate the pneumatic cylinder, which will extend until pick grid 102 has reached its original position. Pinch roller 122, which may have shifted forward when the last bag was entering onto the stacking table, is also retracted so that it does not interfere with stack 300 being removed from pick grid 102.

In a preferred embodiment, most readily described with reference to FIG. 3, the unload signal will also signal actuating cylinder 114 to retract, which will pull up on mounting bar 204, causing friction paddle 110 to be raised up so that it will not interfere with the unloading process. Once pick grid 102 has been raised to its original position and once friction paddle 110 has been retracted to ensure that it will not interfere with the unloading process, the unloading process may begin. A programmable logic controller or other control system may be integrated into this process to further automate the process or relay status information to those tracking throughput or monitoring fault conditions.

Referring again to FIG. 5E, the unloading process may incorporate a variety of manual and/or automated procedures and systems that can be activated based on the unload signal. In this embodiment, pick grid 102 is a relatively flat surface that is comprised of staggered planks 118 that may be tapered toward incoming conveyor system 120 so as not to impede forward progress of the bags. Gaps in between staggered planks 118 can be used to aid the removal of bag stacks that would otherwise sit flush with the table top in the case of a flat table surface. Whether using a manual or an automated stack removal procedure, the gaps between staggered planks 118 provide continuous access around the perimeter of a stack at multiple points along the length of the stacking table. Such access allows for fingers, tools, or robotic manipulators to capture each stack for removal while reducing the potential for damaging the bags or otherwise upsetting the alignment of the stack. In this embodiment basket clamp 302 is lowered onto pick grid 102, which is partially comprised of staggered planks 118. Robotic fingers 304 are aligned with the gaps in between staggered planks 118 so that robotic fingers 304 are able to enter from the sides of the stacking table and capture stack 300 from the sides and underneath without upsetting the alignment of stack 300. Once basket clamp 302 has secured stack 300, the bags are removed from pick grid 102 and the table can then be returned to its initial state to receive the next set of bags.

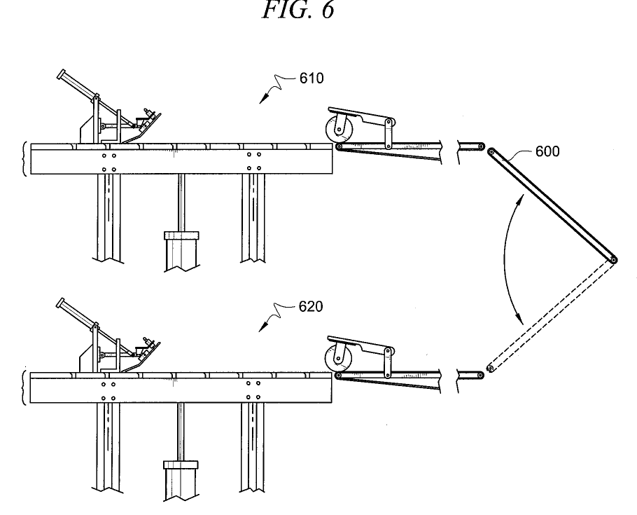

Because the cycle time of the unloading process is a major limitation in achieving the highest rate of bag stacking, it is to be expressly understood that embodiments of the invention include conveyor systems that can route sets of bags to multiple stacking tables so that higher processing rates may be achieved. For example, as shown in FIG. 6, one embodiment may use conveyor system 600 that can alternate sending sets of bags to each of either upper table 610 or lower table 620. In this embodiment, conveyor system 600 will send a set of bags onto the conveyor belt that feeds upper table 610 when upper table 610 is ready to receive a set of bags. When upper table 610 is stacking a set of bags, conveyor system 600 may be lowered in order to feed lower table 620 when lower table 620 is ready to receive a set of bags. Another embodiment of the conveyor system retards the process of sets of bags until one or more of the bag stacking tables have been completely unloaded and are ready to receive the next set of bags.

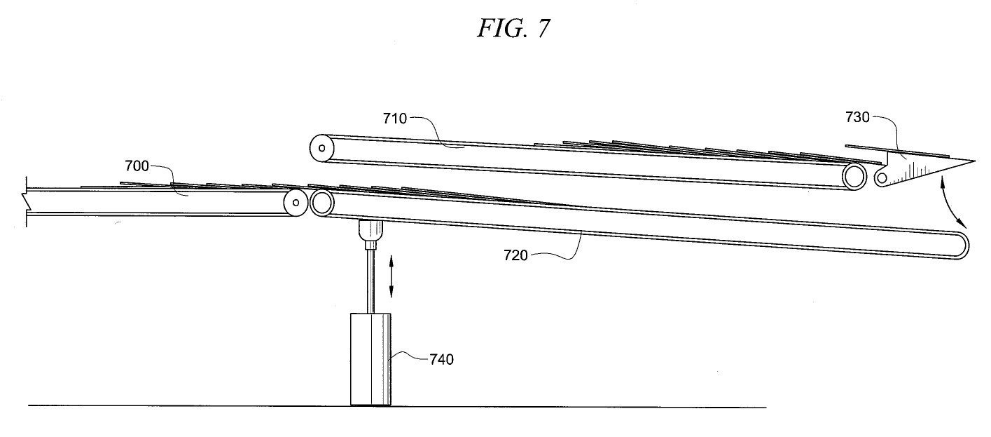

FIG. 7 shows an embodiment of a conveyor system that is designed to feed a stacking table. In this embodiment, conveyor section 700 directly feeds the stacking table. Conveyor section 700 is fed by a two-level conveyor section, which has an upper conveyor component 710 and a lower conveyor component 720. Bags are directed onto either upper conveyor component 710 or lower conveyor component 720 by diverter 730. Conveying rates of upper conveyor component 710 and lower conveyor component 720 do not necessarily have to be the same or even similar. Bags may be diverted onto one or the other of upper conveyor component 710 or lower conveyor component 720 depending on the number of bags to be stacked per set, the relative conveying rates of the conveyor components, or the availability of the conveyor components or stacking table. Upper conveyor component 710 and lower conveyor component 720 may be independently controlled by a system operator or by any number of commercially available control systems, such as a personal computer or a programmable logic controller, in order to efficiently control the flow of bags.

When a set of bags is ready to enter onto conveyor section 700, the two-level conveyor section may be raised or lowered so that the bags can be transferred from either of the two levels (i.e., upper and lower conveyor components) onto conveyor section 700. In the embodiment shown in FIG. 7, cylinder 740 raises the two-level conveyor section when lower conveyor component 720 is transferring bags onto conveyor section 700. Cylinder 740 may then lower the conveyor section when upper conveyor component 710 is transferring bags onto conveyor section 700. In this embodiment, the conveyor system allows for flexibility in handling large numbers of bags by controlling the flow of bags onto conveyor section 700.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for stacking bags in which bags are moved from a conveyor system onto a bag stacking table to be uniformly stacked, said system comprising:
an adjustable table capable of being raised and lowered;
a friction paddle assembly in spaced relationship to said table; and
means for raising and lowering said adjustable table,
wherein as bags are transferred onto said table, said friction paddle assembly monitors the stacking of said bags on said table, signaling said means to incrementally lower said table as each of said bags comes into contact with said friction paddle assembly.

2. The system of claim 1 further comprising a conveyor system.

3. The system of claim 2 wherein said conveyor system comprises a conveyor belt apparatus with a small diameter nose roller and a pinch roller assembly.

4. The system of claim 2 wherein said conveyor system comprises a first conveyor section and a second conveyor section, wherein said first conveyor section is a single level conveyor section that feeds bags onto said table and said second conveyor section is a two level conveyor section that uses a diverter to route bags onto a lower level conveyor component and an upper level conveyor component, and wherein said lower level conveyor component and said upper level conveyor component alternate feeding bags onto said first conveyor section.

5. The system of claim 1 wherein means for raising and lowering said adjustable table comprises one or more cylinders.

6. The system of claim 5 wherein said cylinders are fluid powered.

7. The system of claim 5 wherein said cylinders are electric powered.

8. The system of claim 1 wherein said friction paddle assembly comprises a friction paddle and a sensor wherein the actuation of said friction paddle by each of said bags sends a signal from said sensor to the means for raising and lowering said adjustable table.

9. The system of claim 8 wherein said sensor is a proximity sensor.

10. The system of claim 1 further comprising a controller that is configured to receive signals from said friction paddle assembly and control the incremental lowering of said adjusting table.

11. The system of claim 1 further comprising a means for removing stacks of bags from said adjustable table.

12. A system for stacking bags in which bags are moved from a conveyor system onto two or more bag stacking tables to be uniformly stacked, said system comprising:
a conveyor system;
two or more adjustable tables capable of being raised and lowered;
two or more friction paddle assemblies; and
two or more means for raising and lowering said adjustable tables,
wherein said conveyor system transfers individual sets of bags onto any of said adjustable tables and said friction paddle assemblies monitor the stacking of said bags on said tables, signaling said means to incrementally lower said tables as said bags come into contact with friction paddle assemblies.

13. The system of claim 12 wherein said conveyor system is a conveyor belt apparatus with a small diameter nose roller and a pinch roller assembly.

14. The system of claim 12 wherein said each of said means for raising and lowering said adjustable tables comprises one or more cylinders.

15. The system of claim 14 wherein said cylinders are fluid powered.

16. The system of claim 14 wherein said cylinders are electric powered.

17. The system of claim 12 wherein each of said friction paddle assemblies comprises a friction paddle and a sensor wherein the actuation of each of said friction paddles by each incoming bag sends a signal from each of said sensors to each means for raising and lowering said adjustable tables.

18. The system of claim 17 wherein said sensor is a proximity sensor.

19. The system of claim 12 further comprising a controller that is configured to distribute individual sets of bags to each of said adjustable tables.

20. The system of claim 12 further comprising one or more means for removing stacks of bags from each of said adjustable tables.

21. A method for stacking bags in which bags are moved from a conveyor system onto a bag stacking table to be uniformly stacked, said method comprising the steps of:
transferring bags from said conveyor system onto said adjustable table;
applying friction to said bags using a friction paddle assembly to slow the forward progress of said bags;
detecting the stacking of each said bag onto said table by a sensor;
sending a signal from said sensor to a means for raising and lowering said table when said sensor detects that a bag has been stacked; and
incrementally lowering said adjustable table when said signal is received from said sensor.

22. The method of claim 21 further comprising raising said adjustable table to original position by extending said means for raising and lowering said table after a complete set of bags has been stacked.

23. The method of claim 21 further comprising removing stack of bags from said adjustable table.
